(19) United States
(12) Patent Application Publication
(10) Pub. No.: US 2026/0062186 A1
(43) Pub. Date: Mar. 5, 2026

(54) System and Method for Mixing Drinks

(71) Applicant: Ripcord Beverages, LLC, Salt Lake City, UT (US)

(72) Inventor: Clifton Allenbach, Salt Lake City, UT (US)

(21) Appl. No.: 19/182,527

(22) Filed: Apr. 17, 2025

Related U.S. Application Data
(60) Provisional application No. 63/635,165, filed on Apr. 17, 2024.

(51) Int. Cl. B65D 51/28; A47J 43/27

(52) U.S. Cl. CPC B65D 51/2828; A47J 43/27

(57) ABSTRACT

A beverage mixing system includes a beverage container and a method for mixing a beverage. According to aspects, the technology includes a container body and a container top configured to sit above the container body. The container top includes an opening, a sealed fluid reservoir disposed below the opening, a lid disposed over the opening, having a first configuration in the closed position covering the opening, and a second configuration in the open position leaving the opening uncovered, and a pull tab attached to the sealed fluid reservoir member configured to extend above the opening when the lid is in the second configuration. The pull tab releases a fluid from the fluid reservoir into the container body.

### PRIORITY CLAIM

The Present application claims priority to U.S. Ser. No. 63/635,165 filed Apr. 17, 2024 entitled “SYSTEM AND METHOD FOR MIXING DRINKS” which is incorporated herein by reference in its entirety.

### FIELD OF THE TECHNOLOGY

The present technology relates to mixed drinks and more particularly to a system and method including a container for mixed drinks.

### BACKGROUND OF THE TECHNOLOGY AND RELATED ART

Mixed drinks, including drinks containing alcohol and drinks containing an ice or frozen mixture consistency, are prepared and served in a variety of situations.

Containers and packaging for pre-prepared and pre-mixed drinks typically follow conventional beverage containers and packaging. For example, mixed drinks are shipped in bottles or cans. Chilled specialty mixed drinks, including those containing alcohol and those desirable to be consumed over ice or in a frozen blended consistency, are not well suited for typical bottles or cans. It is therefore desirable to have an improved system and method for mixing drinks.

### BRIEF DESCRIPTION OF THE DRAWINGS

The present technology will become more fully apparent from the following description and appended claims, taken in conjunction with the accompanying drawings. Understanding that these drawings merely depict exemplary aspects of the present technology, they are therefore not to be considered limiting of its scope. It will be readily appreciated that the components of the present technology, as generally described and illustrated in the figures herein, could be arranged and designed in a wide variety of different configurations. Nonetheless, the technology will be described and explained with additional specificity and detail through the use of the accompanying drawings in which:

FIG. 1 is a cross-sectional front view of a mixed beverage container in accordance with one aspect of the technology;

FIG. 2 is a cross-sectional perspective view of the mixed beverage container of FIG. 1;

FIG. 3 is a perspective, cross-sectional view of the top of the mixed beverage container of FIG. 1 configured in accordance with some aspects of the technology;

FIG. 4 is a perspective, cross-sectional view of the top of the mixed beverage container of FIG. 1 configured in accordance with another aspects of the technology;

FIG. 5 is a perspective, cross-sectional view of the body of the mixed beverage container of FIG. 1;

FIG. 6 s a perspective view of a beverage container in accordance with some aspects of the technology;

FIG. 7 is a bottom perspective view of a lid of a beverage container in accordance with aspects of the present technology;

FIG. 8 is a top view of the beverage container of FIG. 5;

FIG. 9 of top perspective view of the lid of FIG. 5 on a beverage container in accordance with aspect of the technology;

FIG. 10 is a top view of a mixed beverage according to aspects of the present technology; and

FIG. 11 is a side cross-sectional view of the mixed beverage of FIG. 8.

### DETAILED DESCRIPTION

The following detailed description of exemplary aspects of the technology makes reference to the accompanying drawings, which form a part hereof and in which are shown, by way of illustration, exemplary aspects in which the technology may be practiced. While these exemplary aspects are described in sufficient detail to enable those skilled in the art to practice the technology, it should be understood that other aspects may be realized and that various changes to the technology may be made without departing from the spirit and scope of the present technology. Thus, the following more detailed description of the aspects of the present technology is not intended to limit the scope of the technology, as claimed, but is presented for purposes of illustration only and not limitation to describe the features and characteristics of the present technology and to sufficiently enable one skilled in the art to practice the technology. Accordingly, the scope of the present technology is to be defined solely by the appended claims.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

It should be understood that the aspects of the technology discussed herein are contemplated for use with any type of flooring system. For purposes of illustrating the various aspects of the methods and systems claimed herein, the discussion below will be primarily directed to describing exemplary embodiments directed to sports floors. It should be noted, however, that the elements and principles discussed herein are applicable to other applications. It is also noted that discussion of methods and systems herein can be interchangeable with respect to specific aspects. In other words, specific discussion of one method or system (or components thereof) herein is equally applicable to other aspects as they relate to the system or method, and vice versa. The following detailed description and exemplary aspects of the technology will be best understood by reference to the accompanying drawings, wherein the elements and features of the technology are designated by numerals throughout.

The present technology describes a mixed beverage system and method that can include a container for storing parts of a mixed beverage separately, with a mechanism for mixing the parts. For example, problems arise in the typical beverage setting where a mixed beverage, and particularly an alcoholic beverage, is pre-mixed instead of mixed just before consumption. Some mixed beverages need ingredients to remain separate because they may store differently at the same temperature. Yet other beverages may be better preserved if portions of the beverage are stored separately.

Yet other problems arise in typical settings involving blended or frozen beverages, including those containing alcohol and those that do not. As discussed above, certain portions of a blended beverage may freeze at different temperatures than others. For example, the blended frozen juice contents of a frozen beverage may freeze at certain temperatures, whereas the alcohol content of the same beverage may not freeze. When combined, the freezing point may be varied, leading to inconsistent freezing. Instead, the present technology relates to storing those components separately, and providing a mixing device that allows the consumer to mix the components prior to consuming the beverage. In aspects of the present technology, the system and method for mixing a beverage may include pulling a tab or cord that is connected to a membrane, sealed void, or sealed fluid reservoir. Upon pulling the cord, the membrane or sealed fluid reservoir is punctured, ripped, or removed such that the fluid is released and combines with other ingredients of the beverage.

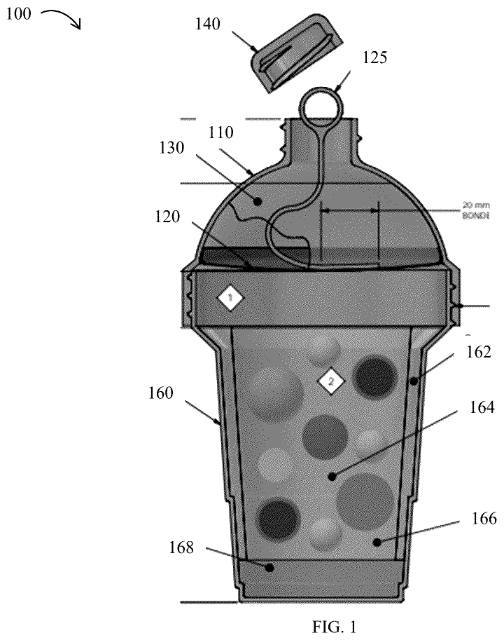

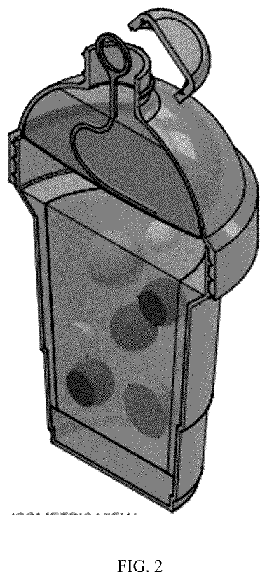

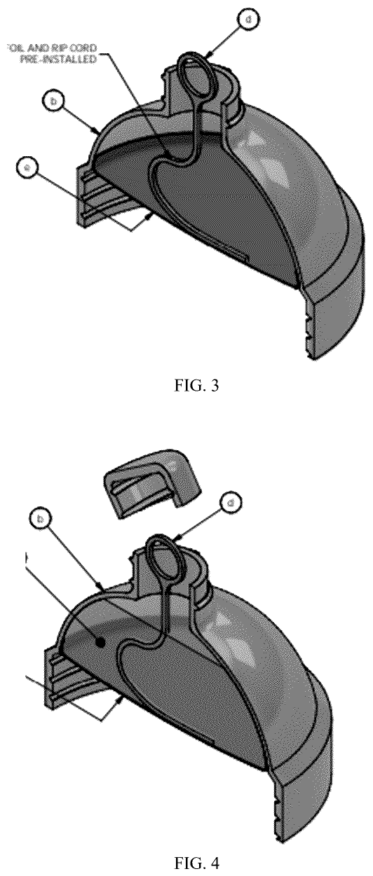

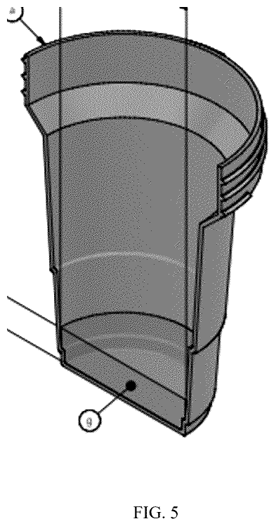

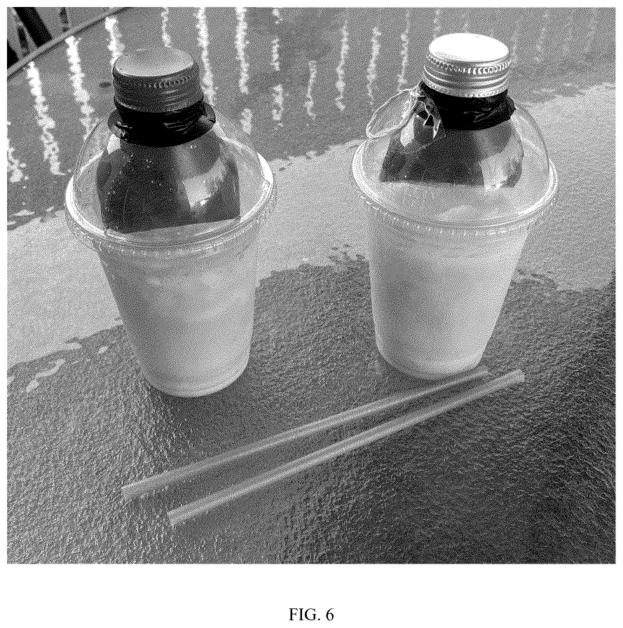

With specific reference now to FIGS. 1-5, a beverage container 100 is shown, having a top portion 110 and a bottom or container body portion 160. The container body 160 may store certain ingredients of the beverage, such as the frozen or blended juices, while the top portion 110 may store separate ingredients, such as the alcohol. The top portion includes a fluid reservoir 120, which may be a sealed void, with a tab 125 connected at one end to the fluid reservoir 120 and having a place to hold or pull the tab at the opposite end. Fluid reservoir 120 may be a foil membrane, or some other membrane, which may contain the fluid sealed in the reservoir until released by activation of the tab 125.

In some aspects of the technology, the top portion 110 includes an opening and a lid 140 covers the opening. For example, the lid 140 may be removed and the tab 125 may be disposed directly below the lid, such that it springs upward and can be held by a user to release the fluid contents 130 in the top portion 110 into the container body 160. For example, FIGS. 1-4 show that once the lid 140 is out of the way, the tab 125 sits above the opening, allowing a user to grab or hold a portion of the tab.

In aspects of the technology, the tab may include a ring, such as a ring through which a user may place a finger for pulling or activating the tab. In other examples, the tab may have any other form of gripping texture or otherwise that will allow a user to hold and pull the tab.

Container body 160 of beverage container 100 is configured to include a perimeter frozen contents 162, a center frozen contents 164, a spirit mixture 166, and a bottom frozen contents 168. The container body 160 may further include various frozen mixtures, which my take the form of balls of various shapes and sizes, such as frozen citrus, frozen fruits, or frozen mixtures of juices, syrups or other fluids. These balls are configured to release their contents at specific timed intervals based on the melting of the beverage, as discussed herein.

FIG. 6 shows a beverage container according to aspects of the technology, where the pull tab is disposed outside of the screw top lid. As shown in red, a fluid reservoir in the top portion of the container holds a first liquid. As shown in yellow, a blended frozen concoction of fluids, which may include juices, ice, and other ingredients, is held in a bottom container. When the tab is pulled, the red fluid reservoir is perforated and the fluid falls into the bottom container to be mixed prior to consumption of the beverage.

As described herein, the mixed beverages may be alcoholic beverages, including those over ice and those having frozen blended consistency. However, aspects of the present technology relate equally to non-alcoholic beverages, such as frozen blended beverages like smoothies and frozen coffees, as well as other beverages not including frozen blended ingredients. For example, it may be advantageous to have certain beverages where an ingredient is mixed moments before consumption rather than pre-mixed, such as protein beverages or other health beverages.

Aspects of the technology also relate to improved methods for mixing beverages, and in particular alcoholic beverages having a frozen consistency. The method includes storing the alcohol separate from the blended frozen ingredients, and mixing the ingredients prior to consumption according to aspects of the technology disclosed herein.

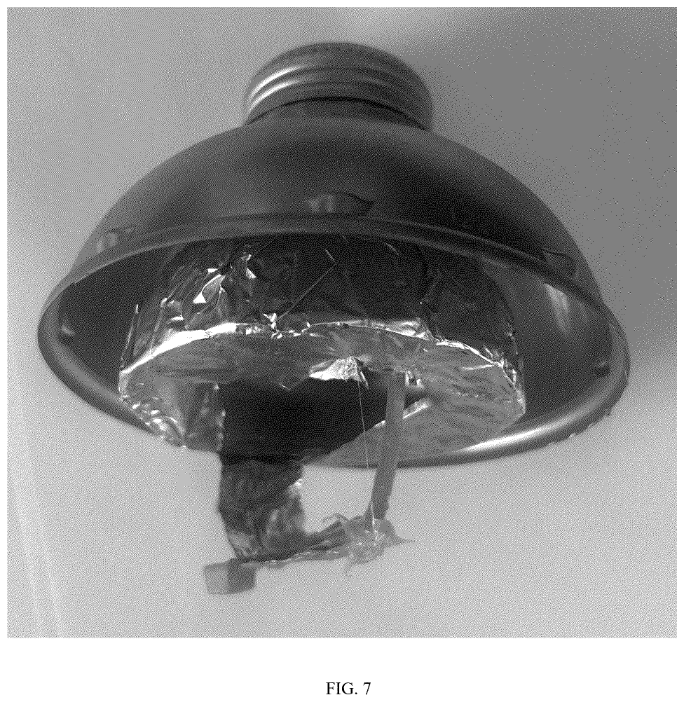

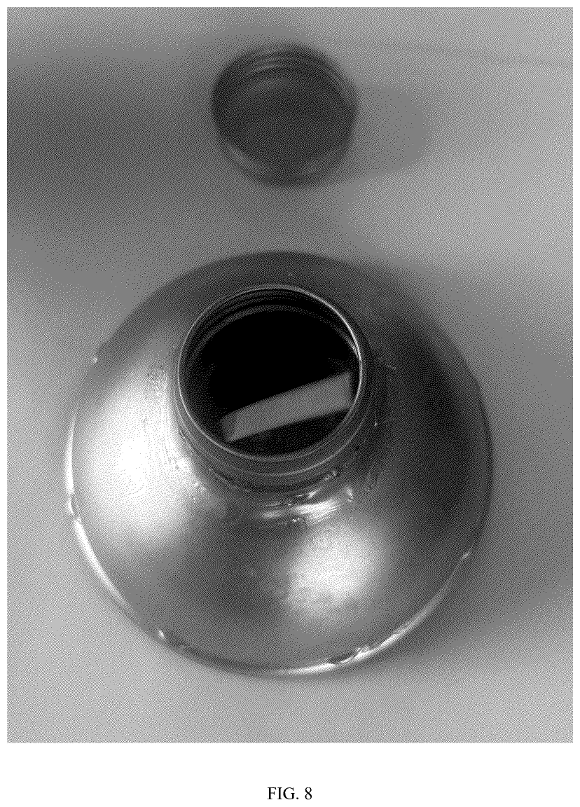

With reference now to FIGS. 7-9, a beverage container according to aspects of the technology is shown. The top of the beverage container includes an upper opening and a lid covering the opening, with a cord disposed below the lid. The cord or pull tab is connected to a membrane of the liquid storing compartment of the top of the beverage container, such that when the tab is pulled, the membrane ruptures and the liquid falls into the bottom container, also shown in the drawings.

According to aspects of the technology, a beverage container includes a top portion having a sealed void configured to hold a liquid, a lid attached to an opening in the top portion, and a tab attached to the sealed void on end of the tab, with the opposite end of the tab disposed above the opening when the lid is removed from the top portion. In aspects, pulling the tab releases the liquid from the sealed void of the top portion.

In other aspects, a beverage mixing system includes a container body and a container top configured to sit above the container body. The container top includes an opening, a sealed fluid reservoir disposed below the opening, a lid disposed over the opening, having a first configuration in the closed position covering the opening, and a second configuration in the open position leaving the opening uncovered, and a pull tab attached to the sealed fluid reservoir member configured to extend above the opening when the lid is in the second configuration. In such aspects, the pull tab releases a fluid from the fluid reservoir into the container body.

In some aspects, the beverage container may be configured to deposit the liquid stored in the top portion of the beverage container into a specific area of the bottom portion of the container. For example, the center portion of the frozen beverage may be of a different consistency than the outside portion of the frozen beverage stored in the bottom of the container. It may be desirable to deposit the alcohol in the upper portion of the container specifically in the center of the bottom contents, as described herein. The tab and membrane described herein may be configured to rupture at a precise location such that the liquid such as alcohol is dispensed at a certain location.

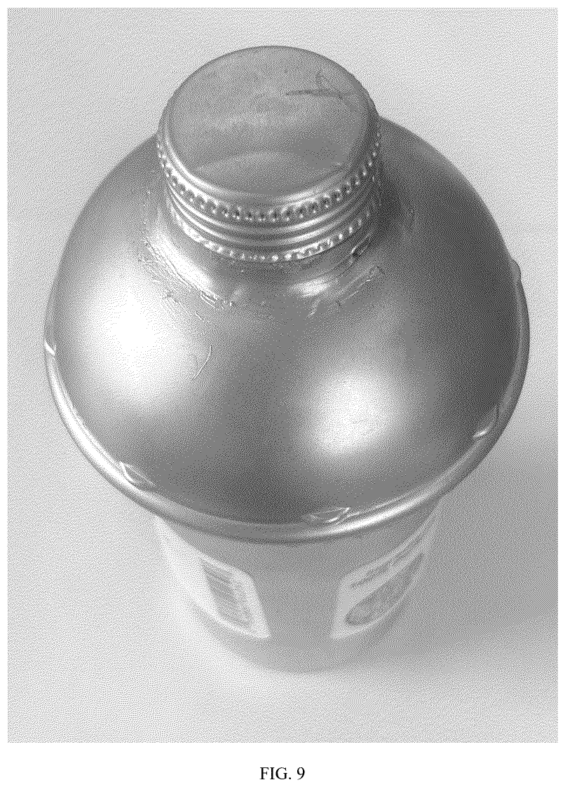

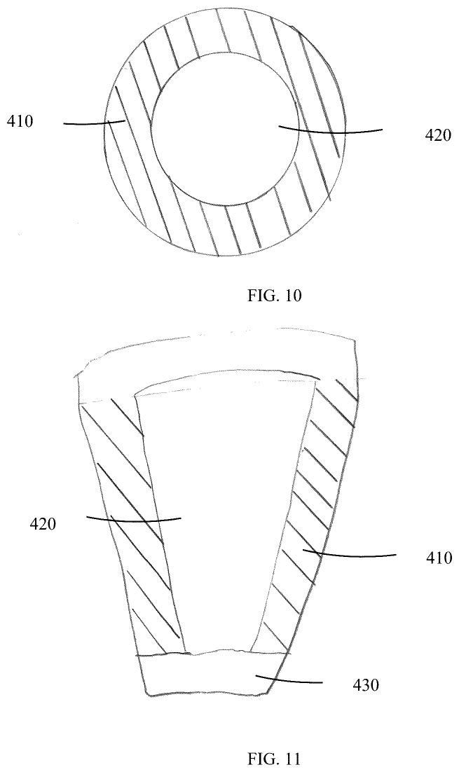

As shown in FIGS. 10-11, the present technology also relates to a method and structure of creating a mixed frozen beverage that includes multiple different materials and placement within the beverage container. For example, FIG. 10 shows a top view of a bottom portion of a beverage container according to certain aspects of the present disclosure. The ring 410 shown with cross hatching is a frozen portion of the beverage that is configured to be placed around the outside of the beverage, while the inside open portion 420 can be filled with a different consistency of beverage ingredients. For example, the outside ring 410 may be a hard frozen concoction of juices and other ingredients, while the inside open portion 420 may contain a softer consistency, such as a shaved ice consistency of frozen juices. In any event, the ingredients may also include whole ingredients, such as flecks of lemon or lime rind. FIG. 9 shows a side view, where a bottom frozen portion 430 of the container also includes a separate section of frozen material, which may be frozen to a different consistency. Bottom frozen portion 430 sits below outside ring 410 and inside open portion 420. As seen in FIG. 9, outside ring 410 may extend around the circumference of the container at the full height of the container, or through any portion of the middle of the height of the container, such as stopping prior to bottom frozen portion 430.

As shown in FIGS. 1-3, the present technology also relates to freezing certain ingredients into balls or other shaped frozen elements that are placed in certain areas of the drink. The frozen ingredients are configured to melt at different rates, as prescribed for a given cocktail or other frozen beverages. For example, a beverage in accordance with the present technology may include frozen lemon balls, which may contain lemon juice, lemon wedges, and or lemon rind. The alcohol in the upper portion of the beverage container may include any combination of alcohols for any type of frozen beverage or frozen cocktails. Similarly, the bottom portion may include any combination of fruit juices and other ingredients required for mixing the frozen beverage.

One aspect of the present technology relates to gourmet frozen cocktails, including a specific delivery system and method for preparing, storing, shipping and mixing that creates a long-lasting high quality beverage. As opposed to known frozen beverages where pouring alcohol over a frozen mixture may create a mediocre immediate result that will melt and become watered down over time, the present technology relates to a specific configuration that allows a frozen beverage to be good from the first sip to the last. For example, the frozen beverage may last up to one hour, with the ingredients slowly melting at certain temperatures in a controlled and purposeful manner so that ingredients are released and continuously exist in the appropriate ratios.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications, combination of features, or changes, if any, are intended to fall within the scope of the present technology as described and set forth herein. In addition, while specific features are shown or described as used in connection with particular aspects of the technology, it is understood that different features may be combined and used with different aspects. Likewise, numerous features from various aspects of the technology described herein may be combined in any number of variations as suits a particular purpose.

More specifically, while illustrative exemplary aspects of the technology have been described herein, the present technology is not limited to these aspects, but includes any and all aspects having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to. ” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

What is claimed is:

1. A beverage container, comprising
a top portion having a sealed void configured to hold a liquid;
a lid attached to an opening in the top portion;
a tab attached to the sealed void on end of the tab, the opposite end of the tab disposed above
the opening when the lid is removed from the top portion;
wherein pulling the tab releases the liquid from the sealed void of the top portion.

2. A beverage mixing system, comprising:
a container body;
a container top configured to sit above the container body, wherein the container top comprises:
an opening;
a sealed fluid reservoir disposed below the opening;
a lid disposed over the opening, having a first configuration in the closed position covering the opening, and a second configuration in the open position leaving the opening uncovered;
a pull tab attached to the sealed fluid reservoir member configured to extend above the opening when the lid is in the second configuration;
wherein the pull tab releases a fluid from the fluid reservoir into the container body.

3. A method of packing a frozen beverage, the method comprising freezing various liquids in various portions of a container;
attaching a lid to a top of the container, the lid comprising:
an opening at the top of the lid,
a sealed void below the opening, the sealed void configured to hold a liquid; and
a tab attached to the sealed void on a first end of the tab, the opposite end of the tab disposed above the opening when the lid is removed from the top portion;
wherein pulling the tab releases the liquid from the sealed void of the lid into the container.

4. The beverage container of claim 1, wherein the sealed void comprises a foil membrane configured to rupture upon pulling of the tab.

5. The beverage container of claim 1, wherein the tab comprises a ring-shaped gripping portion sized to receive a user's finger.

6. The beverage container of claim 1, wherein the sealed void is configured to release the liquid into a designated central region of the container body.

7. The beverage container of claim 1, wherein the container body contains a plurality of frozen balls or shaped frozen elements, each configured to melt at different rates.

8. The beverage container of claim 1, wherein the lid is a removable screw-top lid configured to expose the tab such that the tab extends upward when the lid is removed.

9. The beverage mixing system of claim 2, wherein the sealed fluid reservoir comprises a sealed void containing an alcoholic spirit separate from frozen beverage contents in the container body.

10. The beverage mixing system of claim 2, wherein the pull tab is configured to rupture the sealed fluid reservoir along a predetermined fracture line to control the flow of liquid into the container body.

11. The beverage mixing system of claim 2, wherein the container body contains a perimeter frozen portion surrounding a center frozen portion, the two portions having different freezing consistencies.

12. The beverage mixing system of claim 2, wherein the lid comprises a tamper-evident feature selected from a breakable seal, lock tab, or frangible connector.

13. The beverage mixing system of claim 2, wherein the sealed fluid reservoir is configured such that released liquid is directed toward a central vertical portion of the container body.

14. The method of claim 3, further comprising freezing a perimeter ring of beverage ingredients of a first consistency and a center portion of beverage ingredients of a second consistency within the container.

15. The method of claim 3, wherein freezing various liquids comprises forming shaped frozen elements configured to melt at predetermined rates during consumption.

16. The method of claim 3, wherein attaching the lid further comprises positioning the tab such that the tab springs upward into an accessible position when the lid is removed.

17. The method of claim 3, wherein the sealed void contains an alcoholic liquid stored separately from frozen juice ingredients in the container.

18. The method of claim 3, further comprising configuring the sealed void and tab such that pulling the tab releases liquid into a central region of the frozen contents.
